(19) United States
(12) Patent Application Publication
(10) Pub. No.: US 2003/0162100 A1
(43) Pub. Date: Aug. 28, 2003

(54) Lithium secondary battery for mounting on substrate

(76) Inventors: Yasufumi Takahashi, Kobe-shi (JP); Seiji Yoshimura, Kobe-shi (JP); Maruo Kamino, Kobe-shi (JP)

Correspondence Address: KUBOVCIK & KUBOVCIK, SUITE 710, 900 17TH STREET NW, WASHINGTON, DC, 20006

(21) Appl. No.: 10/369,596

(22) Filed: Feb. 21, 2003

(30) Foreign Application Priority Data
Feb. 26, 2002 (JP) 2002-049160

(51) Int. Cl. H01M 10/40; H01M 4/50; H01M 2/16; H01M 4/40

(52) U.S. Cl. 429/333; 429/231.95; 429/224; 429/254

(57) ABSTRACT

A lithium secondary battery to be mounted on a substrate including a positive electrode, a negative electrode containing an alloy of lithium and aluminum, and a non-aqueous electrolyte containing a solute and a solvent; wherein the solvent contains propylene carbonate and diethylene glycol dialkyl ether. More preferably, the solvent also contains trialkyl phosphate.

### FIELD OF THE INVENTION

The present invention relates to a lithium secondary battery for mounting on a substrate, such as a printed circuit board. Specifically, the present invention relates to a lithium secondary battery to be mounted on a substrate by a reflow treatment and the like.

### BACKGROUND OF THE INVENTION

A lithium secondary battery is small and light in weight, and has a high energy density and excellent storage characteristics. Because of such features, the lithium secondary battery has been widely used as a main power source and a memory back-up power source.

When the lithium secondary battery is used as a memory back-up power source, the battery is directly mounted on a substrate, such as a printed circuit board and the like, to stabilize its operation over a long period.

When the lithium secondary battery is directly mounted on the substrate, an end of a metal lead for output of current is connected on an external terminal of the lithium secondary battery by spot welding, laser beam welding, or the like, and then the other end of the metal lead is inserted into a hole created on the substrate such as a printed board, and is soldered.

As explained above, to solder the other end of the metal lead installed on the external terminal of the lithium secondary battery includes some problems. That is, the soldering process for each battery is troublesome, and productivity is not good, as well as cost is high.

To solve such problems automatic soldering has been tried wherein a solder cream is applied on a portion of the substrate where the lithium secondary battery is to be mounted, the battery is placed on the surface of the substrate where the solder cream is applied, and the battery with the substrate are placed in a reflow furnace. The combination is heated at a high temperature of about 230˜270° C. for a short period in the reflow furnace so as to fuse the solder and to mount the lithium secondary battery onto the substrate together with other electric parts. This series of procedures is called a reflow treatment.

During the reflow treatment, the lithium secondary battery itself is exposed to a high temperature atmosphere of 230˜270° C. as described above. Therefore, vigorous reactions between battery components, i.e., a positive electrode, a negative electrode, a non-aqueous electrolyte, separator, and the like, occur. There are problems that internal pressure of the battery significantly increases to cause leakage of fluid.

It is proposed in Japanese Patent Laid-open publication Nos. 2000-40525 and 2000-48859 to use a non-aqueous electrolyte prepared by dissolving a lithium salt having a sulfonic group in an organic solvent containing sulfolane or 3-methyl sulfolane as a main ingredient to inhibit evaporation of the non-aqueous electrolyte during the reflow treatment and to prevent pressure inside the battery from increasing.

However, even if the method proposed in the above-mentioned publications is applied, if an amount of sulfolane is not suitable, or the choice of solvent in which sulfolane is dissolved is not suitable, there are still problems that conductivity of the non-aqueous electrolyte dramatically decreases or stability of the lithium secondary battery at a high temperature cannot be sufficiently improved.

### OBJECT OF THE INVENTION

An object of the present invention is to provide a lithium secondary battery for mounting on a substrate wherein leakage of fluid hardly occurs and internal pressure does not dramatically increase in an environment of a high temperature such as a reflow treatment.

### SUMMARY OF THE INVENTION

The present invention is characterized in that a lithium secondary battery to be mounted on a substrate comprises a positive electrode, a negative electrode made of an alloy of lithium and aluminum, and a non-aqueous electrolyte containing a solute and a solvent; wherein the solvent contains propylene carbonate and diethylene glycol dialkyl ether.

### BRIEF DESCRIPTION OF THE DRAWINGS

FIG. 1 is a cross section of an embodiment of a lithium secondary battery of the present invention.

FIG. 2 is a graph showing a relationship between an amount of propylene carbonate (PC) in a solvent for a non-aqueous electrolyte and a number of cycles of charge and discharge until discharge capacity is decreased to half of the discharge capacity at the first cycle.

FIG. 3 is a graph showing a relationship between an amount of trialkyl phosphate (trimethyl phosphate and triethyl phosphate) and a number of cycles of charge and discharge until discharge capacity is decreased to half of the discharge capacity at the first cycle.

[Explanation of Elements]

1: positive electrode

2: negative electrode

3: separator

4: battery case

4a: positive electrode case

4b: negative electrode case

5: positive electrode current collector

6: negative electrode current collector

7: gasket

### DETAILED EXPLANATION OF THE INVENTION

In the present invention, using a solvent containing propylene carbonate and diethylene glycol dialkyl ether together with a negative electrode made of an alloy of lithium and aluminum can inhibit a reaction of the non-aqueous electrolyte with the positive and negative electrodes, and especially the negative electrode, even if the battery is heated at a high temperature of about 230˜270° C. As a result, an increase of internal pressure of the battery can be prevented, and it is possible to prevent leakage of fluid. Furthermore, charge and discharge cycle characteristics can be improved as the result of inhibition of an increase of the internal pressure of the battery.

The reasons for using a solvent containing both propylene carbonate and diethylene glycol dialkyl ether in the present invention are that if only propylene carbonate is used, stability of the battery at a high temperature increases, but conductivity of the non-aqueous electrolyte decreases and charge and discharge characteristics are deteriorated, and that if only diethylene glycol dialkyl ether is used, conductivity of the non-aqueous electrolyte is higher and charge and discharge characteristics are improved, but stability of the battery at a high temperature decreases.

An amount of propylene carbonate contained in the solvent is, from standpoints of improvement of stability of the non-aqueous electrolyte at a high temperature and of conductivity of the non-aqueous electrolyte, preferably in a range of 3˜50 volume %, and more preferably in a range of 5˜40 volume %. Therefore, an amount of diethylene glycol dialkyl ether contained is preferably in a range of 97˜50 volume %, and more preferably in a range of 95˜60 volume %.

Use of a negative electrode made of an alloy containing lithium and aluminum makes it possible to inhibit a reaction between the non-aqueous electrolyte-containing the solvent described above and the negative electrode at a high temperature of about 230˜270° C.

Concrete examples to be used as the diethylene glycol dialkyl ether are diethylene glycol dimethyl ether, diethylene glycol diethyl ether, diethylene glycol di-n-propyl ether, and the like. They can be used alone or as a mixture.

In another aspect of the present invention, trialkyl phosphate can be included in the solvent. Therefore, a solvent containing propylene carbonate, diethylene glycol dialkyl ether and trialkyl phosphate can be used.

When trialkyl phosphate is added to the solvent, stability of the battery at a high temperature can be further improved. That is, leakage of fluid due to an elevation of internal pressure of the battery at a higher temperature can be prevented, and elevation of internal resistance in the battery can also be inhibited to improve charge and discharge characteristics.

An amount of trialkyl phosphate contained in the solvent is preferably 0.1˜10 weight %, and more preferably, 0.5˜5 weight % relative to the total amount of propylene carbonate and diethylene glycol dialkyl ether.

It is not known in detail why the solvent containing trialkyl phosphate can further improve the stability at a high temperature. However, a coating is formed on the surface of the negative electrode by the solvent containing propylene carbonate, diethylene glycol dialkyl ether and trialkyl phosphate, and the coating is believed to participate in the improvement of the stability at a high temperature.

There is no limitation regarding the trialkyl phosphate to be used in the present invention. A trialkyl phosphate having an alkyl group of 1˜5 carbon atoms is preferably used. Trimethyl phosphate and triethyl phosphate are preferable and trimethyl phosphate is more preferable.

Manganese oxide is particularly preferable as an active material for the positive electrode in the lithium secondary battery of the present invention. Manganese oxide having a spinel structure is preferable. When manganese oxide is used as the active material for the positive electrode, a reaction between the positive electrode and the non-aqueous electrolyte can be further inhibited, and charge and discharge characteristics can be further improved.

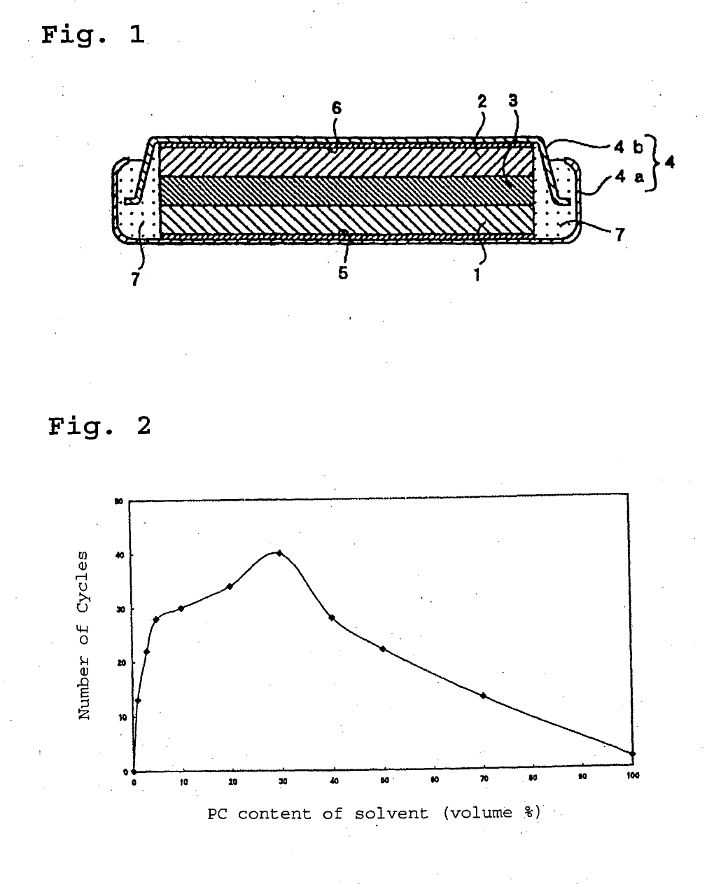

FIG. 1 is a drawing illustrating a cross section of an embodiment of a lithium secondary battery of the present invention.

As shown in FIG. 1, a separator 3 impregnated with a non-aqueous electrolyte is placed between a positive electrode 1 and a negative electrode 2, and the sandwiched separator, the positive and negative electrodes are housed in a battery case 4 comprising a positive electrode case 4a and a negative electrode case 4b. The positive electrode 1 is connected to the positive electrode case 4a through a positive electrode current collector 5. The negative electrode 2 is connected to the negative electrode case 4b through a negative electrode current collector 6. The positive electrode case 4a and the negative electrode case 4b are electrically insulated by a gasket 7 which is an insulation packing, and are joined together by caulking to form a coin shaped lithium secondary battery.

In this embodiment, the positive electrode 1 is formed by a mixture of a positive electrode active material, a conductive agent and a binding agent. As the positive electrode active material, a transition metal oxide which is known to be generally used for a lithium secondary battery can be used. For example, titanium oxide, vanadium oxide, manganese oxide, cobalt oxide, nickel oxide, niobium oxide, molybdenum oxide, and the like can be used. As mentioned above, manganese oxide is particularly preferable. Furthermore, as is also mentioned above, when manganese oxide having a spinel structure is used, a reaction between the positive electrode and the non-aqueous electrolyte at a high temperature can be further inhibited to obtain further excellent stability at a high temperature and excellent charge and discharge characteristics.

As a conductive agent to be used for the positive electrode 1, materials generally known for use as a conductive agent in a lithium secondary battery can be used. For example, natural graphite such as scale like graphite and dirt-like graphite, artificial graphite, carbon black, acetylene black, ketjen black, carbon fiber, and the like, can be used. It is preferable to use graphite together with acetylene black as the conductive agent to improve charge and discharge characteristics. Particularly, a mixture of graphite and acetylene black at a ratio of 3/7˜7/3 by weight is preferable.

As a binding agent to be used for the positive electrode 1, materials generally known for use as a binding conductive agent in a lithium secondary battery can be used. For example, polytetrafluoroethylene, polyfluorovinylidene, polyvinyl pyrrolidone, polyvinyl chloride, polyethylene, polypropylene, polyfluoroethylene propylene, ethylene-propylene-diethane polymer, styrene-butadiene rubber, carboxymethylcellulose, fluororubber, and the like can be used. Polyfluoroethylene propylene which has excellent stability at a high temperature is particularly preferable because the battery is heated at about 230˜270° C. during reflow treatment. An amount of 1-10 weight % polyfluoroethylene propylene is preferable to be used.

As the negative electrode 2, an alloy of lithium and aluminum is used to control a reaction with the non-aqueous electrolyte. A ratio of lithium and aluminum in a mole ratio of 1:5˜1:2 is preferable. Other elements, for example, lead, tin, magnesium, manganese, and the like, can be contained in the alloy of lithium and aluminum with the limitation that stability at a high temperature and charge and discharge characteristics are not reduced.

As the separator 3, polyphenylene sulfide is preferable for inhibiting a reaction with the non-aqueous electrolyte during reflow treatment. It is possible to mix other polymers having a high heat stability or inorganic fiber or cellulose resin to enhance strength with the limitation that the amount is in a range that does not reduce heat stability.

As the non-aqueous electrolyte to be impregnated in the separator 3, a suitable solute dissolved in a solvent containing propylene carbonate and diethylene glycol dialkyl ether, or a solvent containing propylene carbonate, diethylene glycol dialkyl ether, and trialkyl phosphate can be used.

Other solvents can be included in the solvent of the non-aqueous electrolyte with the limitation that desirable characteristics are not deteriorated. Ethylene carbonate; cyclic carboxylate, for example, y-butyrolactone, and the like; sulfolane (SL); chain ethers, for example, 1,2-diethoxyethane, 1,2-ethoxymethoxyethane, and the like; chain carbonates, for example, dimethyl carbonate, diethyl carbonate, ethylmethyl carbonate, and the like; chain esters, for example, methyl acetate, and the like; and cyclic ethers, for example, tetrahydorofuran, and the like, can be illustrated.

As a solute in the non-aqueous electrolyte, it is preferable to use a solute having excellent stability at a high temperature. For example, lithium trifluoromethanesulfonate (LiCF₃SO₃), lithium bis-trifluoromethylsulfonylimide (LiN(CF₃SO₂)₂) lithium bis-pentafluoroethylsulfonylimide (LiN(C₂F₅SO₂)₂), lithium tris-trifluoromethylsulfonylmethide (LiC(CF₃SO₂)₃), and the like can be illustrated. A concentration of the solute in the electrolyte is preferably 0.3˜1.5 mol/l, more preferably 0.5˜1.0 mol/l.

As the positive electrode case 4a and the negative electrode case 4b, stainless steel and the like, can preferably be used to form a desirable shape by pressing. The positive electrode current collector 5 is placed between the positive electrode 1 and the positive electrode case 4a. As the positive electrode current collector 5, a collector prepared by coating an electrically-conductive paint which is a mixture of graphite powder and water glass (sodium silicate) on the inside of the positive electrode case 4a, and a mesh collector made of stainless steel, titanium, or the like, can preferably be used.

The negative electrode current collector 6 is placed between the negative electrode 2 and the negative electrode case 4b. As the negative electrode current collector 6, a collector prepared by coating an electrically-conductive paint which is a mixture of graphite powder and water glass on the inside of the negative electrode case 4b, and a mesh collector made of stainless steel, titanium, or the like, can preferably be used.

### DESCRIPTION OF PREFERRED EMBODIMENTS

Embodiments of a lithium secondary battery of the present invention are explained in detail below. It is of course understood that the present invention can be modified within the scope and spirit of the appended claims.

### EXAMPLE 1

Positive and negative electrodes and a non-aqueous electrolyte prepared as described below were used to prepare a coin shaped lithium secondary battery as shown in FIG. 1 for mounting on a substrate.

[Preparation of Positive Electrode]

Li_{1.22}Mn_{1.78}O₄ having a spinel structure as a positive electrode active material, an electrically-conductive agent which is a mixture of graphite and acetylene black (1:1 by weight), and polyfluoroethylene propylene were mixed in a ratio of 90:5:5 by weight to form a disc having a diameter of 4 mm and a thickness of 1.2 mm, and the disc was dried in a vacuum at 250° C. for two hours.

[Preparation of Negative Electrode]

Lithium-aluminum alloy was prepared electrochemically to prepare a negative electrode. The lithium-aluminum alloy was stamped out to form a disc, the negative electrode, having a diameter of 4 mm and a thickness of 0.3 mm. The ratio of lithium and aluminum in the alloy was 1:2 by mol.

[Preparation of Non-aqueous Electrolyte]

Lithium bis-trifluoromethylsulfonylimide (LiN(CF₃SO₂)₂) as a solute (lithium salt) was dissolved in a solvent mixture of propylene carbonate (PC) and diethylene glycol dimethyl ether (DDME) in a ratio of 30:70 to a concentration of 0.75 mol/l to prepare a non-aqueous electrolyte.

As shown in FIG. 1, the negative electrode 2 prepared above, a separator 3 of polyphenylene sulfide, and the positive electrode 1 prepared above were placed in turn on a negative electrode current collector 6 made of a stainless mesh welded onto a stainless steel negative electrode case 4b. A gasket 7 which was an insulation packing of polyphenylene sulfide was placed on the inside of a negative electrode case 4b, and the non-aqueous electrolyte prepared above was added. Then a stainless steel positive electrode case 4a in which a positive electrode current collector 5, comprising a coating of a electrically-conductive paint which is a mixture of graphite powder and water glass was formed to connect the positive electrode 1, and was placed on the negative electrode case 4b. The positive electrode case 4a was caulked to seal the case and to prepare the lithium secondary battery of Example 1.

### EXAMPLE 2

A lithium secondary battery of Example 2 was prepared in the same manner as Example 1 except that a composite oxide of lithium, boron and manganese (Li—B—Mn composite oxide) was used as a positive electrode active material. The Li—B—Mn composite oxide was prepared by mixing lithium hydroxide (LiOH), boron oxide (B₂O₃) and manganese dioxide (MnO₂) in an atomic ratio of 0.50:0.01:1.00, treating the mixture at 375° C. in air for 20 hours, and then grinding.

### EXAMPLE 3

A lithium secondary battery of Example 3 was prepared in the same manner as Example 1 except that diethylene glycol diethyl ether (DDEE) was used instead of diethylene glycol dimethyl ether (DDME) to prepare a non-aqueous electrolyte.

### EXAMPLE 4

A lithium secondary battery of Example 4 was prepared in the same manner as Example 1 except that diethylene glycol di-n-propyl ether (DDPE) was used instead of diethylene glycol dimethyl ether (DDME) to prepare a non-aqueous electrolyte.

### EXAMPLE 5

A lithium secondary battery of Example 5 was prepared in the same manner as Example 1 except that vanadium pentoxide (V₂O₅) was used as a positive electrode active material.

### COMPARATIVE EXAMPLE 1

A lithium secondary battery of Comparative Example 1 was prepared in the same manner as Example 1 except that only 1,2-dimethoxyethane (DME) was used as a solvent.

### COMPARATIVE EXAMPLE 2

A lithium secondary battery of Comparative Example 2 was prepared in the same manner as Example 1 except that a mixture of sulfolane (SL) and diethylene glycol dimethyl ether (DDME) at a ratio of 30:70 by volume was used as a solvent.

### COMPARATIVE EXAMPLE 3

A lithium secondary battery of Comparative Example 3 was prepared in the same manner as Example 1 except that a mixture of propylene carbonate (PC) and sulfolane (SL) at a ratio of 30:70 by volume was used as a solvent.

### COMPARATIVE EXAMPLE 4

A lithium secondary battery of Comparative Example 4 was prepared in the same manner as Example 1 except that a mixture of sulfolane (SL) and 1,2-dimethoxyethane (DME) at a ratio of 30:70 by volume was used as a solvent.

### COMPARATIVE EXAMPLE 5

A lithium secondary battery of Comparative Example 5 was prepared in the same manner as Example 1 except that a lithium metal disc having a diameter of 4 mm and a thickness of 0.3 mm was used as a negative electrode.

[Evaluation of Leakage and Charge and Discharge Characteristics of Battery After Reflow Treatment]

Each battery prepared above was tested for voltage and resistance. Five batteries with good results, i.e., no shorts, and the like, of each of Examples 1˜5 and Comparative Examples 1˜5 were selected for further evaluation.

The selected batteries were preheated at 180° C. for one minute, were passed through a reflow furnace in which the highest temperature was 250° C. and the lowest temperature of 180° C. was close to the entrance and exit of the furnace, and then left for self-cooling to room temperature. The batteries were then inspected to determine whether or not there was leakage. The number of batteries of the five batteries from each of the Examples and Comparative Examples having leakage is identified in Table 1.

Then only batteries which did not leak were checked for voltage and resistance to choose batteries having a good condition, i.e., free from shorts, and the like. Selected batteries were charged at a constant current of 0.1 mA to a final charge voltage of 3.0 V, and were discharged at a constant current of 0.1 mA to a final discharge voltage of 2.0 V. This charge and discharge was considered one cycle. Charge and discharge were repeated and the number of cycles until discharge capacity was reduced to half of the initial discharge capacity (at the first cycle) are shown in Table 1.

TABLE 1

| | | | Composition | | Number of |
|---|---|---|---|---|---|
| | Positive | Negative | of Non- | Leakage | Cycles |
| | Electrode | Electrode | electrolyte | (number) | (number) |
| Example 1 | Li_{1.22}Mn_{1.78}O₄ | Li—Al | PC:DDME = | 0 | 40 |
| | | alloy | 30:70 | | |
| Example 2 | Li—B—Mn | Li—Al | PC:DDME = | 0 | 30 |
| | composite | alloy | 30:70 | | |
| | oxide | | | | |
| Example 3 | Li_{1.22}Mn_{1.78}O₄ | Li—Al | PC:DDEE = | 0 | 38 |
| | | alloy | 30:70 | | |
| Example 4 | Li_{1.22}Mn_{1.78}O₄ | Li—Al | PC:DDPE = | 0 | 36 |
| | | alloy | 30:70 | | |
| Example 5 | V₂O₅ | Li—Al | PC:DDME = | 1 | 18 |
| | | alloy | 30:70 | | |
| Comparative | Li_{1.22}Mn_{1.78}O₄ | Li—Al | DME | 3 | 8 |
| Example 1 | | alloy | | | |
| Comparative | Li_{1.22}Mn_{1.78}O₄ | Li—Al | SL:DDME = | 1 | 4 |
| Example 2 | | alloy | 30:70 | | |
| Comparative | Li_{1.22}Mn_{1.78}O₄ | Li—Al | PC:SL = | 1 | 3 |
| Example 3 | | alloy | 30:70 | | |
| Comparative | Li_{1.22}Mn_{1.78}O₄ | Li—Al | SL:DME = | 2 | 2 |
| Example 4 | | alloy | 30:70 | | |
| Comparative | Li_{1.22}Mn_{1.78}O₄ | Li metal | PC:DDME = | 5 | — |
| Example 5 | | | 30:70 | | |

As clear from the results shown in Table 1, the lithium secondary batteries in Examples 1˜5 in which lithium-aluminum alloy was used for the negative electrode, and a mixed solvent of propylene carbonate (PC) and diethylene glycol dimethyl ether (DDME) was used as the non-aqueous electrolyte had less problem of leakage after the reflow treatment and had excellent charge and discharge characteristics.

As is clear from a comparison of the results of Examples 1, 2 and 5, the use of a manganese oxide as an active material prevents leakage caused by the reflow treatment and provides good charge and discharge characteristics and manganese oxide having a spinel structure further improves charge and discharge characteristics as compared to a manganese composite oxide.

### EXAMPLES 6˜13

Lithium secondary batteries of Examples 6˜13 were prepared in the same manner as Example 1 except that ratios by volume of propylene carbonate (PC) and diethylene glycol dimethyl ether (DDME) were varied to prepare a non-aqueous electrolyte. That is, ratios of PC and DDME by volume were 1:99 in Example 6, 3:97 in Example 7, 5:95 in Example 8, 10:90 in Example 9, 20:80 in Example 10, 40:60 in Example 11, 50:50 in Example 12, and 70:30 in Example 13.

### COMPARATIVE EXAMPLES 6 and 7

Lithium secondary batteries of Comparative Examples 6 and 7 were prepared in the same manner as Example 1 except that a non-aqueous electrolyte was prepared using only propylene carbonate (PC) or diethylene glycol dimethyl ether (DDME) as a solvent. That is, a ratio of PC and DDME by volume was 0:100 and 100:0 in Comparative Examples 6 and 7, respectively.

[Evaluation of Leakage and Charge and Discharge Characteristics of Battery After Reflow Treatment]

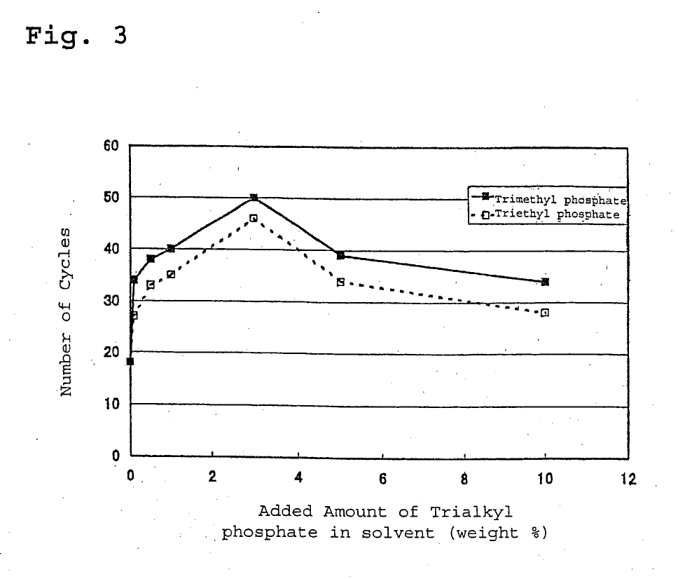

Batteries prepared in Examples 6˜13 and Comparative Examples 6 and 7 were evaluated in the same manner as Example 1 to determine whether leakage of fluid occurred after the reflow treatment. The number of batteries among five batteries of each Example and Comparative Example having a leakage problem after the reflow treatment is shown in Table 2. Batteries which did not leak were applied for further evaluation in the same manner as Example 1. The number of cycles (charge and discharge cycles) until discharge capacity was reduced to half of the discharge capacity of the first cycle was measured. The results are shown in Table 2 and FIG. 2. The results of Example 1 are also shown in Table 2 and FIG. 2.

TABLE 2

| | Composition of | | | Number of |
|---|---|---|---|---|
| | Non-electrolyte | | Leakage | Cycles |
| | PC | DDME | (number) | (number) |
| Comparative | 0 | 100 | 5 | — |
| Example 6 | | | | |
| Example 6 | 1 | 99 | 1 | 13 |
| Example 7 | 3 | 97 | 0 | 22 |
| Example 8 | 5 | 95 | 0 | 28 |
| Example 9 | 10 | 90 | 0 | 30 |
| Example 10 | 20 | 80 | 0 | 34 |
| Example 1 | 30 | 70 | 0 | 40 |
| Example 11 | 40 | 60 | 0 | 28 |
| Example 12 | 50 | 50 | 0 | 22 |
| Example 13 | 70 | 30 | 0 | 13 |
| Comparative | 100 | 0 | 1 | 2 |
| Example 7 | | | | |

Positive Electrode: Li_{1.22}Mn_{1.78}O₄,
Negative Electrode: Li—Al Alloy

As is clear from the results shown in Table 2 and FIG. 2, in Examples 7˜12 in which the content ratio of propylene carbonate (PC) was in a range of 3˜50 volume %, leakage caused by reflow treatment was especially prevented, stability at a high temperature was excellent and charge and discharge characteristics were improved. When propylene carbonate (PC) was in a range of 5˜40 volume %, charge and discharge characteristics were more improved.

### EXAMPLE 14

A lithium secondary battery of Example 14 was prepared in the same manner as Example 1 except that a mixture of propylene carbonate (PC) and diethylene glycol dimethyl ether (DDME) (30:70 by volume) to which was added 3 weight % of trimethyl phosphate relative to the total amount of PC and DDME, was used as a solvent for a non-aqueous electrolyte.

### EXAMPLE 15

A lithium secondary battery of Example 15 was prepared in the same manner as Example 14 except that triethyl phosphate was used instead of trimethyl phosphate.

### EXAMPLE 16

A lithium secondary battery of Example 16 was prepared in the same manner as Example 14 except that a Li—B—Mn composite oxide as in Example 2 was used as a positive electrode active material.

### EXAMPLE 17

A lithium secondary battery of Example 17 was prepared in the same manner as Example 14 except that vanadium pentoxide (V₂O₅) as in Example 5 was used as a positive electrode active material.

### EXAMPLE 18

A lithium secondary battery of Example 18 was prepared in the same manner as Example 14 except that diethylene glycol diethyl ether (DDEE) was used instead of diethylene glycol dimethyl ether (DDME).

### EXAMPLE 19

A lithium secondary battery of Example 19 was prepared in the same manner as Example 14 except that diethylene glycol di-n-propyl ether (DDPE) was used instead of diethylene glycol dimethyl ether (DDME).

### EXAMPLE 20

A lithium secondary battery of Example 20 was prepared in the same manner as Example 14 except that trimethyl phosphate was added to a mixture of propylene carbonate (PC), diethylene glycol dimethyl ether (DDME) and diethylene glycol diethyl ether (DDEE) (30:50:20 by volume) in an amount of 3 weight % relative to the total amount of PC, DDME and DDEE instead of to the mixture of propylene carbonate (PC) and diethylene glycol dimethyl ether (DDME).

### EXAMPLE 21

A lithium secondary battery of Example 21 was prepared in the same manner as Example 14 except that trimethyl phosphate was not added. Please note that the lithium secondary battery in Example 21 is the same as the battery in Example 1.

### EXAMPLE 22

A lithium secondary battery of Example 22 was prepared in the same manner as Example 18 except that trimethyl phosphate was not added to the non-aqueous electrolyte.

### EXAMPLE 23

A lithium secondary battery of Example 23 was prepared in the same manner as Example 20 except that trimethyl phosphate was not added to the non-aqueous electrolyte.

### COMPARATIVE EXAMPLES 8˜11

Batteries of Comparative Examples 8˜11 were prepared in the same manner as Comparative Examples 1˜4.

[Evaluation of Leakage and Charge and Discharge Characteristics of Battery After Reflow Treatment]

Batteries prepared in Examples 14˜23 and Comparative Examples 8˜11 were evaluated to determine whether leakage occurred after a reflow treatment in the same manner as Example 1 except that the batteries were passed through a reflow furnace in which the highest temperature was 260° C., and the lowest temperature was 180° C. close to the entrance and exit of the furnace. The number of batteries having leakage among five batteries in each Example and Comparative Example was identified in Table 3.

The number of cycles until discharge capacity was reduced to half of the discharge capacity of the first cycle was measured for batteries which did not have leakage after the reflow treatment. The results are shown in Table 3.

TABLE 3

| | | | | Number of |
|---|---|---|---|---|
| | Positive | Composition of | Leakage | Cycles |
| | Electrode | Non-electrolyte | (number) | (number) |
| Example 14 | Li_{1.22}Mn_{1.78}O₄ | PC:DDME = 30:70, | 0 | 50 |
| | | trimethyl phosphate | | |
| | | (3 wt %) | | |
| Example 15 | Li_{1.22}Mn_{1.78}O₄ | PC:DDME = 30:70, | 0 | 46 |
| | | trimethyl phosphate | | |
| | | (3 wt %) | | |
| Example 16 | Li—B—Mn | PC:DDME = 30:70, | 0 | 40 |
| | composite | triethyl phosphate | | |
| | oxide | (3 wt %) | | |
| Example 17 | V₂O₅ | PC:DDME = 30:70, | 0 | 34 |
| | | trimethyl phosphate | | |
| | | (3 wt %) | | |
| Example 18 | Li_{1.22}Mn_{1.78}O₄ | PC:DDEE = 30:70, | 0 | 46 |
| | | trimethyl phosphate | | |
| | | (3 wt %) | | |
| Example 19 | Li_{1.22}Mn_{1.78}O₄ | PC:DDPE = 30:70, 3 | 0 | 29 |
| | | weight % trimethyl | | |
| | | phosphate | | |
| Example 20 | Li_{1.22}Mn_{1.78}O₄ | PC:DDME:DDEE = | 0 | 48 |
| | | 30:50:20, | | |
| | | trimethyl phosphate | | |
| | | (3 wt %) | | |
| Example 21 | Li_{1.22}Mn_{1.78}O₄ | PC:DDME = 30:70 | 0 | 18 |
| Example 22 | Li_{1.22}Mn_{1.78}O₄ | PC:DDEE = 30:70 | 3 | 18 |
| Example 23 | Li_{1.22}Mn_{1.78}O₄ | PC:DDME:DDEE = | 1 | 23 |
| | | 30:50:20 | | |
| Comparative | Li_{1.22}Mn_{1.78}O₄ | DME | 5 | — |
| Example 8 | | | | |
| Comparative | Li_{1.22}Mn_{1.78}O₄ | SL:DDME = 30:70 | 4 | 3 |
| Example 9 | | | | |
| Comparative | Li_{1.22}Mn_{1.78}O₄ | PC:SL = 30:70 | 4 | 2 |
| Example 10 | | | | |
| Comparative | Li_{1.22}Mn_{1.78}O₄ | SL:DME = 30:70 | 4 | 2 |
| Example 11 | | | | |

Negative Electrode : Li—Al Alloy

As clear from the results shown in Table 3, lithium secondary batteries of Examples 14˜20 in which trialkyl phosphate was added to the mixed solvent could prevent leakage of fluid and had excellent charge and discharge cycle characteristics as compared to lithium secondary batteries of Examples 21˜23 in which trialkyl phosphate was not added to the mixed solvent. Therefore, when trialkyl phosphate is added to a mixed solvent of propylene carbonate and diethylene glycol dialkyl ether, leakage can be prevented even when a battery is treated at a higher temperature during a reflow treatment, and charge and discharge characteristics can be further improved.

### EXAMPLES 24˜33

In Examples 24˜28, an amount of trimethyl phosphate added to a mixed solvent for a non-aqueous electrolyte was varied. That is, lithium secondary batteries of Example 24˜28 were prepared in the same manner as the battery of Example 14 except that an amount of trimethyl phosphate was 0.1 weight % in Example 24, 0.5 weight % in Example 25, 1.0 weight % in Example 26, 5.0 weight % in Example 27, and 10.0 weight % in Example 28.

In Examples 29˜33, an amount of triethyl phosphate added to a mixed solvent for a non-aqueous electrolyte was varied. That is, lithium secondary batteries of Example 29˜33 were prepared in the same manner as the battery of Example 15 except that an amount of triethyl phosphate was 0.1 weight % in Example 29, 0.5 weight % in Example 30, 1.0 weight % in Example 31, 5.0 weight % in Example 32, and 10.0 weight % in Example 33.

[Evaluation of Leakage and Charge and Discharge Characteristics of Battery After Reflow Treatment]

Batteries prepared in Examples 24˜33 were evaluated in the same manner as Example 14. That is, leakage after the reflow treatment and effects of the reflow treatment on charge and discharge characteristics were determined. The results are shown in Table 4. The results of Examples 14, 15 and 21 are also shown in Table 4. The relationship of an amount of trialkyl phosphate added and the number of cycles to reduce discharge capacity to half of the discharge capacity of the first cycle is shown in FIG. 3.

TABLE 4

| | Trialkyl phosphate | | | Number of |
|---|---|---|---|---|
| | | Amount added | Leakage | Cycles |
| | Kind | (weight %) | (number) | (number) |
| Example 21 | — | 0 | 0 | 18 |
| Example 24 | Trimethyl | 0.1 | 0 | 34 |
| | phosphate | | | |
| Example 25 | Trimethyl | 0.5 | 0 | 38 |
| | phosphate | | | |
| Example 26 | Trimethyl | 1.0 | 0 | 40 |
| | phosphate | | | |
| Example 14 | Trimethyl | 3.0 | 0 | 50 |
| | phosphate | | | |
| Example 27 | Trimethyl | 5.0 | 0 | 39 |
| | phosphate | | | |
| Example 28 | Trimethyl | 10.0 | 0 | 34 |
| | phosphate | | | |
| Example 29 | Triethyl | 0.1 | 0 | 27 |
| | phosphate | | | |
| Example 30 | Triethyl | 0.5 | 0 | 33 |
| | phosphate | | | |
| Example 31 | Triethyl | 1.0 | 0 | 35 |
| | phosphate | | | |
| Example 15 | Triethyl | 3.0 | 0 | 46 |
| | phosphate | | | |
| Example 32 | Triethyl | 5.0 | 0 | 34 |
| | phosphate | | | |
| Example 33 | Triethyl | 10.0 | 0 | 28 |
| | phosphate | | | |

Positive Electrode: Li_{1.22}Mn_{1.78}O₄,
Negative Electrode: Li—Al Alloy,
Solvent Mixture PC:DDME = 30:70

As is clear from the results shown in Table 4 and FIG. 3, when trialkyl phosphate was added in a range of 0.5˜5 weight %, charge and discharge characteristics were remarkably improved.

In the embodiment and Examples described above, a coin shaped lithium secondary battery is mentioned and was prepared. However, a shape or size of the lithium secondary battery of the present invention is not limited to the battery of the embodiment and Examples.

### ADVANTAGES OF THE INVENTION

The present invention can inhibit reaction of a non-aqueous electrolyte with a positive electrode and/or a negative electrode, especially with the negative electrode, when a lithium secondary battery is exposed heat by a reflow tratment, i.e, is heated at a high temperature of about 230˜270° C. It is possible to prevent leakage of fluid due to an increase of internal pressure of the battery, and to prevent an increase of internal resistance of the battery. Therefore, the present invention can provide a lithium secondary battery to be mounted on a substrate having excellent stability at a high temperature and excellent charge and discharge characteristics.

What is claimed is:

1. A lithium secondary battery to be mounted on a substrate, said battery comprising a positive electrode containing a positive electrode active material, a negative electrode containing an alloy of lithium and aluminum, and a non-aqueous electrolyte containing a solute and a solvent;
wherein the solvent contains propylene carbonate and diethylene glycol dialkyl ether.

2. The lithium secondary battery for mounting on a substrate according to claim 1, wherein the diethylene glycol dialkyl ether is at least one ether selected from the group consisting of diethylene glycol dimethyl ether, diethylene glycol diethyl ether, and diethylene glycol di-n-propyl ether.

3. The lithium secondary battery according to claim 1, wherein the lithium secondary battery is mounted on the substrate by a reflow treatment.

4. The lithium secondary battery according to claim 2, wherein the lithium secondary battery is mounted on the substrate by a reflow treatment.

5. The lithium secondary battery according to claim 1, wherein propylene carbonate is included in the solvent in a range of 3˜50 volume %.

6. The lithium secondary battery according to claim 2, wherein propylene carbonate is included in the solvent in a range of 3˜50 volume %.

7. The lithium secondary battery according to claim 1, wherein propylene carbonate is included in the solvent in a range of 5˜40 volume %.

8. The lithium secondary battery according to claim 2, wherein propylene carbonate is included in the solvent in a range of 5˜40 volume %.

9. The lithium secondary battery according to claim 1, wherein the solvent further contains trialkyl phosphate.

10. The lithium secondary battery according to claim 2, wherein the solvent further contains trialkyl phosphate.

11. The lithium secondary battery according to claim 9, wherein said trialkyl phosphate is contained in the solvent in a range of 0.1˜10 weight % relative to a total amount of propylene carbonate and diethylene glycol dialkyl ether.

12. The lithium secondary battery according to claim 10, wherein said trialkyl phosphate is contained in the solvent in a range of 0.1˜10 weight % relative to a total amount of propylene carbonate and diethylene glycol dialkyl ether.

13. The lithium secondary battery according to claim 9, wherein said trialkyl phosphate is contained in the solvent in a range of 0.5˜5 weight % relative to a total amount of propylene carbonate and diethylene glycol dialkyl ether.

14. The lithium secondary battery according to claim 10, wherein said trialkyl phosphate is contained in the solvent in a range of 0.5˜5 weight % relative to a total amount of propylene carbonate and diethylene glycol dialkyl ether.

15. The lithium secondary battery according to claim 9, wherein said trialkyl phosphate is trimethyl phosphate.

16. The lithium secondary battery according to claim 10, wherein said trialkyl phosphate is trimethyl phosphate.

17. The lithium secondary battery according to claim 1, wherein said positive electrode contains manganese oxide as the positive electrode active material.

18. The lithium secondary battery according to claim 2, wherein said positive electrode contains manganese oxide as the positive electrode active material.

19. The lithium secondary battery according to claim 17, wherein said manganese oxide has a spinel structure.

20. The lithium secondary battery according to claim 18, wherein said manganese oxide has a spinel structure.

21. The lithium secondary battery according to claim 1, wherein said lithium secondary battery further contains a separator between said positive electrode and said negative electrode, and the separator comprises polyphenylene sulfide.

22. The lithium secondary battery according to claim 2, wherein said positive electrode contains manganese oxide as the positive electrode active material.
